(19) United States
(12) Patent Application Publication
(10) Pub. No.: US 2016/0162263 A1
(43) Pub. Date: Jun. 9, 2016

(54) VISUAL AND INTERACTION DESIGN INTEGRATED DEVELOPMENT INFRASTRUCTURE

(71) Applicant: Frank Brunswig, Heidelberg (DE)

(72) Inventor: Frank Brunswig, Heidelberg (DE)

(21) Appl. No.: 14/563,884

(22) Filed: Dec. 8, 2014

(51) Int. Cl. G06F 9/44; H04L 29/06

(52) U.S. Cl. CPC G06F 8/20; G06F 8/70; H04L 65/403

(57) ABSTRACT

An integrated development application of a server is disclosed. The integrated development application receives visual design content for an application from an application designer client. The integrated development application generates a link between the visual design content and development entities for the application. The link includes a design status code and a development status code and identifies a repository storing a source code of the development entities. The integrated development application identifies an application developer client associated with the development entities for the application. The integrated development application updates a development status of the development entities based on updates to the development status code for the source code of the development entities received at the repository from the application developer client.

### TECHNICAL FIELD

The present application relates generally to the field of design process of software applications, and, in one specific example, to an integrated development infrastructure.

### BACKGROUND

A visual design process includes a designer using authoring tools to design specific user interface components for software applications. The visual design documents are typically stored on file shares, newsletter, or wikis in a file server.

A development process includes a developer developing a software application containing the user interface (UI) specified in the design documents. The source code for the UI is typically stored in a repository (e.g., source code controlling system such as Git or Perforce) that is separate from a file share server where the design documents are stored. As such, the software developer has to know the correct location of the newest version of the visual design documents to access the correct information. Because the visual design process is decoupled from the development process, the design documents are not directly linked to the implemented user interface. Thus, a software designer or developer has to access different databases or repositories to identify the status of the implementation of the user interface. When the software developer needs to consult with the software designer, the software developer has to actively search for the corresponding software design document in a separate database or Wiki.

### BRIEF DESCRIPTION OF THE DRAWINGS

Some embodiments are illustrated by way of example and not limitation in the figures of the accompanying drawings in which:

FIG. 1 is a block diagram depicting an example environment within which example embodiments may be deployed;

FIG. 2 is an interaction diagram illustrating interactions between a client machine of a designer, a server machine, and a client machine of a developer;

FIG. 3 is a flowchart depicting an example embodiment of a method for operating an integrated development application;

FIG. 4 is a flowchart depicting an example embodiment of a method for determining a level of completeness for a development application;

FIG. 5 is a flowchart depicting an example embodiment of a method for generating a status report for a development application; and

FIG. 6 is a block diagram of an example computer system on which methodologies described herein may be executed.

### DETAILED DESCRIPTION

In the following description, for purposes of explanation, numerous specific details are set forth in order to provide an understanding of various embodiments of the inventive subject matter. It will be evident, however, to those skilled in the art, that embodiments may be practiced without these specific details. Further, to avoid obscuring the inventive subject matter in unnecessary detail, well-known instruction instances, protocols, structures, and techniques have not been shown in detail. As used herein, the term “or” may be construed in an inclusive or exclusive sense. The term “user” may be construed to include a person or a machine. The term “interface” may be construed to include an application program interface (API) or a user interface. The term “database” may be construed to include a database or a NoSQL or non-relational data store (e.g., Google's BigTable or Amazon's Dynamo). The term “business object” may mean an object that represents an entity of a business inside a software application. For example, a business object may represent a person (e.g., an employee of a company) or a concept (e.g., a process within a company) inside an enterprise information management software application.

A design integrated development infrastructure is disclosed. The design integrated development infrastructure enables a collaborative approach between application designers and application developers. Typically, application designers design the user interface visuals and store the visual design content in files, newsletters, or wikis. Application developers typically store their source code in a Git repository. Because the source code and the visual design content are stored in different repositories, the visual design process is decoupled from the application development process. Application developers need to identify the correct location in a directory or wiki documents, and the newest version of the visual design content. Frequent changes in the visual design content also result in decoupled development where no links exist between the visual design of user interfaces and the implemented user interfaces. Newsletters and wiki change notifications may be lost in the email inbox of application developers. Another unintended consequence of this decoupled process is that application developers potentially work with outdated design content.

Furthermore, application developers may wish to easily identify the application designer for consultation or for questions. Typical practice involves a pull process where the application developers reach out to the application designers for answers. As such, a lot of back and forth exchanges between the application developers and the application designers may also get lost in email inboxes. Another drawback of the conventional process is that application designers are unaware of the overview status of the applications unless the application designers reach out directly to the corresponding application developers.

The design integrated development infrastructure integrates visual design documents (e.g., documentation, slides, diagrams of user interfaces) and development content (e.g., HyperText Markup Language (HTML) files and Javascript files) in a same repository (e.g., Git repository). Application designers have the ability to check-in and check-out these design documents from the same repository. Entities may include views and pages. The design integrated development infrastructure may also establish naming conventions that are described in design documents and implemented in HTML. The design integrated development infrastructure enables tracking of a level of completeness of entities (e.g., by comparing number of designed elements with number of implemented elements) using the naming conventions.

In one example embodiment, the design integrated development infrastructure includes an integrated development application (IDA). The IDA receives visual design content for an application from an application designer client. The IDA generates a link between the visual design content and development entities for the application. The link includes a design status code and a development status code and identifies a repository storing a source code of the development entities. The IDA identifies an application developer client associated with the development entities for the application. The IDA updates a development status of the development entities based on updates to the development status code for the source code of the development entities received at the repository from the application developer client.

In another example embodiment, the IDA updates the design status code in the link based on updates to the visual design content received from the application designer client. The IDA communicates the design status code of the visual design content to the application developer client.

In another example embodiment, the IDA generates a notification to the application designer client to test the application based on the development status of the development entities. The IDA receives an approval notification or a rejection notification from the application designer client in response to the notification.

In another example embodiment, the IDA tracks a number of visual design documents and a number of implemented views based on the visual design documents. The IDA computes a level of completeness of the application based on the ratio of the number of visual design documents to the number of implemented views. The IDA then stores the level of completeness in an XML or JavaScript Object Notation (JSON) file in the same repository of the source code and the visual design content.

In another example embodiment, the IDA determines that the application is ready for review by the application designer client based on the level of completeness of the application. The IDA then generates a link to a test server to the application designer client to test the application.

In another example embodiment, the IDA determines a change in the development status code identifying a completion of the development entities. The IDA then generates a message to the application designer client to notify them of a change in the development status code identifying a completion of the development entities. The message includes a URL link to a test server associated with the development entities.

In another example embodiment, the IDA receives a rejection message from the application designer client. The rejection message includes comments from the application designer client. The IDA changes the development status code to a rejection status.

In another example embodiment, the IDA receives an approval message from the application designer client. The IDA then changes the development status code to an approval status.

In another example embodiment, the IDA generates a portal database containing identifying information of individual developers and individual visual designers, and their corresponding contact information. The IDA identifies at least one individual developer associated with the application and at least one individual visual designer associated with the application. The IDA then communicates a change in a visual design status to the at least one individual developer and a change in the development status to the at least one individual visual designer.

In another example embodiment, the IDA stores the visual design content and the development content in a same Git repository. The visual design content contains visual design for user interfaces for the application to be developed. The development content in the Git repository may contain HTML files and Javascript files corresponding to the application to the developed.

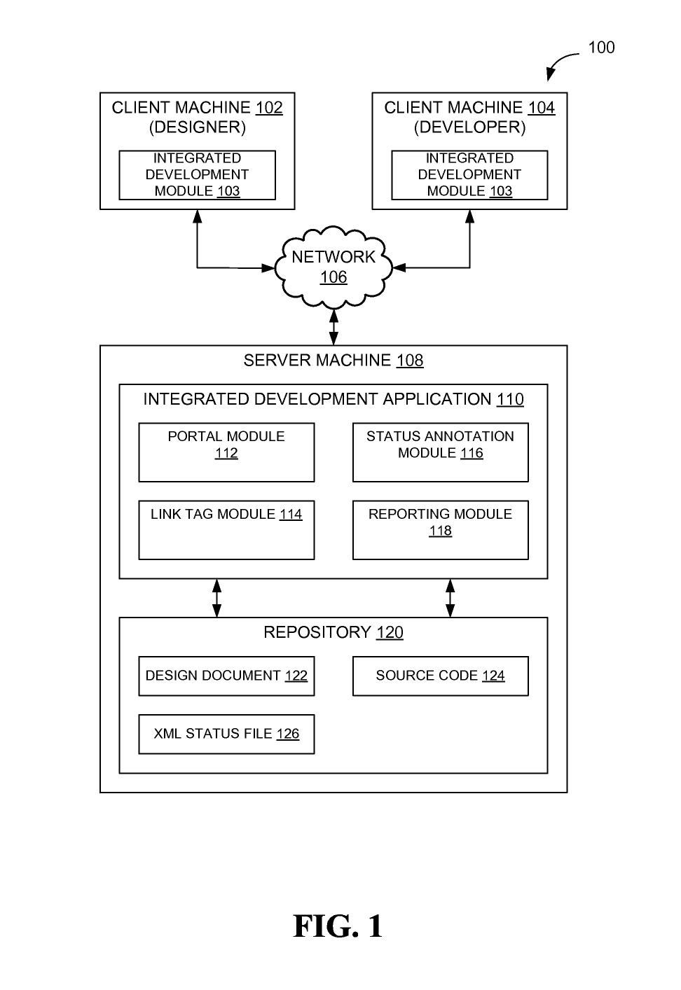

FIG. 1 is a block diagram depicting an example environment 100 within which example embodiments may be deployed. The environment 100 includes at least two client machines (e.g., client machine 102 of an application designer, client machine 104 of an application developer). For example, the client machines 102, 104 may be personal computers or mobile computing devices.

In one example embodiment, the client machine 102 may be used to design user interfaces for an application. The client machine 102 may execute a web browser or a software application to design and create a user interface for an application. For example, the web browser may be any browser commonly used to access a network of computers such as the World Wide Web. The web browser may load a user interface to create and model business objects. In another embodiment, the software application may include a software tool (e.g. Photoshop from Adobe, Inc. or Powerpoint from Microsoft, Inc.) to create a visualization of user interfaces for the application to be developed.

In one example embodiment, the client machines 102, 104 each include an integrated development module 103 configured to communicate with an integrated development application 110 at a server machine 108. The integrated development module 103 in the client machine 102 enables the application designer to upload and download the visual design content to and from the repository 120 of the server machine 108. The integrated development module 103 in the client machine 102 can also retrieve a development status of the application from the server machine 108. The designer or author of the visual design document can work on a local copy and at dedicated points in time, the designer can upload the visual design documents to the Git repository 120 manually. If other colleagues need access to the visual design documents, the integrated development module 103 provides a corresponding download (pull).

The integrated development module 103 in the client machine 104 enables the application developer to upload the source code of the application to the same repository 120 of the server machine 108. The integrated development module 103 in the client machine 104 can also retrieve a design status of the application from the server machine 108. The integrated development module 103 technically links the visual design content with the corresponding development content in the same repository 120. The integrated development module 103 also enables the client machine 102 to interface with client machine 104 and share information with respect to the design and development of the application.

In another example embodiment, all files for a specific application project are stored locally on the client machine 102 or 104 and checked-in and checked-out via a Git graphical user interface (GUI) plugin. The specific local application content may be deployed to a local web server instance so that the developer can use the different browsers like Google Chrome and Microsoft Internet Explorer (desktop version only) for testing the local version. In addition, the developer can also use mobile devices to test the application with this local instance. For example, all dependent libraries may be downloaded and cached in a local repository folder of the client machine 102.

The environment 100 includes one or more server machines (e.g., server machine 108). The server machine 108 executes the integrated development application (IDA) 110. The IDA 110 technically links the visual design content generated by the client machine 102 with the development content generated by client machine 104. The IDA 110 stores the linked visual design content and development content in the same repository 120. The IDA 110 also tracks a status of the development of the application based on status updates from the client machines 102, 104. The IDA 110 also tracks a level of completeness of the development of the application based on the number of entities (e.g., a user interface dialog box) designed by the client machine 102 and the number of entities implemented (e.g., source code to generate the user interface dialog box) and developed by the client machine 104. As such, the IDA 110 interfaces with both client machines 102 and 104 to share information with respect to the design and development of the application.

In one example embodiment, the IDA 110 includes a portal module 112, a link tag module 114, a status annotation module 116, and a reporting module 118. The portal module 112 provides a consolidated place for the client machine 102 to access the status of the development of the application and to contact the corresponding developer. The portal module 112 also provides a consolidated place for the client machine 104 to access the status of the visual design of the application and to contact the corresponding designer.

In one example embodiment, the project portal module 112 includes a database containing information on the roles of the team members associated with the application (e.g., project lead, user interface developer, data developer, visual designer, interaction designer, information developer) including their email addresses. More than one role can be assigned to a team member. All information of the project portal database is also available via the integrated development module 103.

The visual and interaction design documents are part of the development content such as HTML or JavaScript files and are stored in the same repository 120 (e.g. Git repository) under a path, for example, <project-name>/doc.

The link tag module 114 generates a link between entities described in the design documents and the corresponding entities in the development content such as HTML files. The link tag module 114 uses naming conventions so that each page describing a specific entity in the design document is tagged as #LinkName=entity name# where the # tags and the = sign are the eye catchers for the content of the described link.

An example of a link is illustrated below:

#LinkName=mycalendar.view.appointment.appointmentdetail#

The link name content is not case-sensitive. The text in the link may be translated to uppercase when looking for corresponding links in other content such as HTML source. The link can appear in the content (e.g. on a PowerPoint page) or in the comment pane or other areas of the page.

In a similar way, the link tag module 114 defines corresponding entities in the development content as Extensible Markup Language (XML) views with an XML attribute linkName=“Entity Name”. The linkName=“ tag and the ” at the end are the eye catchers for the content of the described link.

An example of a link with XML views is illustrated below:

linkName=”MyCalendar.view.Appointment.AppointmentDetail”
<Page title=″{i18n>view.Appointment.appointmentDetail}″
showNavButton=″true″ navButtonPress=″onBack″
linkName=”MyCalendar.view.Appointment.AppointmentDetail”>

Based on the link names, a Git repository plug-in in the repository 120 triggered in the post commit phase (upload) looks for these linked entities and tracks the level of completeness (e.g., the number of designed entities versus the number of implemented entities). The level of completeness can be stored in XML or JSON status file 126 which are also stored in the Git repository 120. The information of these status files 126 are also available in the integrated development module 103 so that the designer can be updated to an overview of the completeness of the application.

The status annotation module 116 generates a status of a specific entity in the design documents or in the development content via status annotations. For the visual design documents, the design status may be, for example, “ready for development.” This “ready” status informs the application developer that the implementation can be started because the design is now available. In another example embodiment, the designers together with the application developers may agree on a list of design status codes. In one example embodiment, the status of the design entity may be expressed at the end of the link name separated by comma like #LinkName=entity name, status#.

An example of a design status code is illustrated below:

#LinkName=mycalendar.view.appointment.appointmentdetail,ready#

In the XML status file 126, the status, like “ready for review”, informs the app developer that the entity is ready for review by the corresponding application designer. In addition, the status “reviewed” marks this entity as reviewed and ready for further process. The status annotation module 116 may express the status of the development entity at the end of the link name separated by comma like linkName=“Entity Name, Status”.

An example of a development status code is illustrated below:

```
          linkName=”MyCalendar.view.Appointment.
AppointmentDetail,reviewed”
          <Page title=″{i18n>view.Appointment.appointmentDetail}″
          showNavButton=″true″ navButtonPress=″onBack″
          linkName=”MyCalendar.view.Appointment.
AppointmentDetail,reviewed”>
```

A development status code of “ready” informs the application designer that the implementation is now ready for review by the designer. A development status code of “rejected” marks the entity as reviewed and rejected with issues. The issues may be further described in a ticket. A development status code of “approved” marks the entity as reviewed and approved.

The reporting module 118 stores the overall number of status of all entities within an application in an XML status file 126 which is also stored in the Git repository 120. This XML status file 126 is the source for the operative reporting on the application level of completeness. In addition, all of the application's meta-information about the location of the Git repository 120 is stored in the portal module 112. For the overall reporting of an application, the reporting module 118 performs a batch job that collects and aggregates all XML status files 126 from all projects based on the information in the portal module 112. The reporting module 118 then presents the results in an easy to read format such as using a spreadsheet or a chart. In addition, the reporting module 118 can also generate a historical reporting based on the Git history of the XML status file 126.

The server machine 108 includes the repository 120 to store design document 122, source code 124, and XML status file 126.

The client machines 102, 104, and server machine 108 may be coupled to each other via a network 106. The network 106 enables communication between systems. Accordingly, the network 106 may be a mobile telephone network, a plain old telephone (POTS) network, a wired network, a wireless network (e.g., a WiFi or WiMax network), or any suitable combination thereof. The communication may be based on any communication protocols. Examples of communication protocols include Transmission Control Protocol/Internet Protocol (TCP/IP), HyperText Transfer Protocol (HTTP), File Transfer Protocol (FTP), Simple Mail Transfer Protocol (SMTP), Post Office Protocol (POP), Internet Message Access Protocol (IMAP), Wireless Access Protocol (WAP), Gopher, wireless internet protocols, and instant messaging protocols. The network 106 may be implemented using the Internet, a wide area network (WAN), a local area network (LAN), or any suitable combination thereof.

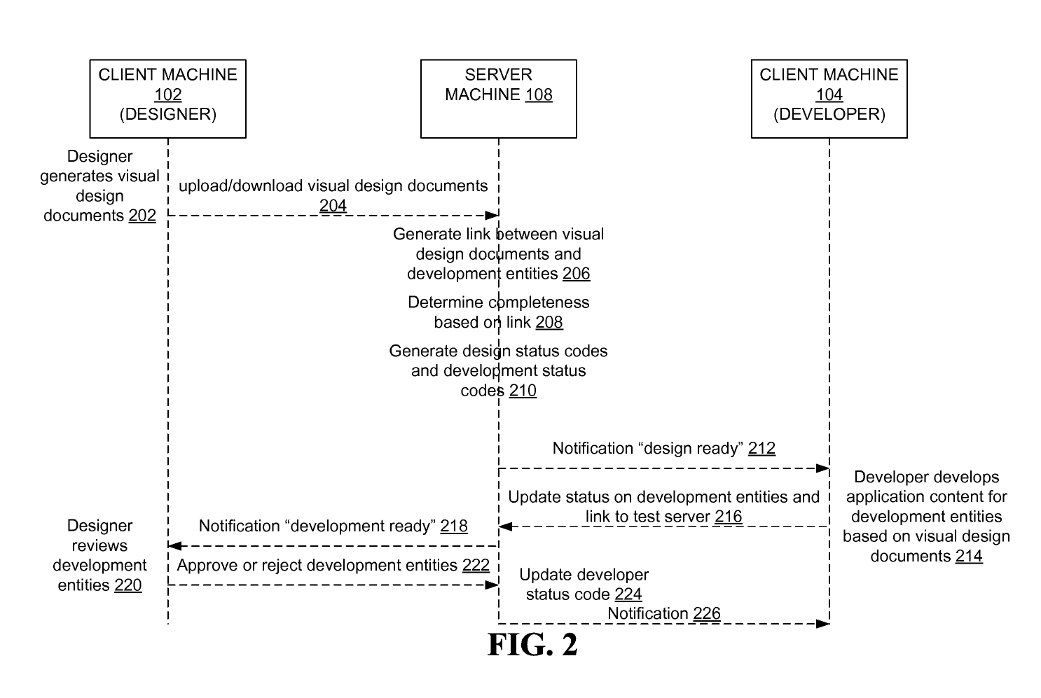

FIG. 2 is an interaction diagram illustrating interactions between the client machine 102 of a designer, the server machine 108, and the client machine 104 of a developer. At operation 202, the designer uses tools to generate visual design documents for an application under development. In one example, the designer uses tools such as PowerPoint from Microsoft, Inc. and Photoshop from Adobe, Inc. to generate the visual design documents on the client machine 102. The visual design documents include visual representation of the proposed user interfaces and their corresponding operations. For example, the visual design documents include screenshots, examples of user interfaces, documentation of operation and interaction between the user interfaces. At operation 204, the client machine 102 uploads the visual design documents to the server machine 108. In one example embodiment, the integrated development module 103 of the client machine 102 communicates the visual design documents to the integrated development application 110 of the server machine 108. For example, the integrated development module 103 accesses the portal module 112 of the integrated development application 110 to upload the visual design documents.

The server machine 108 stores the visual design documents in the same repository 120 of the source code 124 associated with the application being developed. For example, the server machine 108 stores the design document 122 in the repository 120. In one example, the repository 120 may include a source code repository containing an integrated development plug-in to communicate with the integrated development module 103. The repository 120 may be a distributed revision control system repository such as, for example, a Git repository.

At operation 206, the server machine 108 links the visual design documents to the development entities. For example, the visual design documents may identify and describe visual elements, technical functionalities, visual design of user interfaces, contextual information, and defaults. Development entities may include Javascript corresponding to one or more of the elements from the visual design documents. For example, a Javascript component may address the functionality described in the visual design documents. As such, the server machine 108 correlates components in the visual design documents to the corresponding development entities. In one example embodiment, the link tag module 114 tags each page describing a specific entity in the design document with a link such as #LinkName=entity name#. In another example embodiment, the link tag module 114 of the integrated development application 110 tags a development entity with a link to the corresponding description in the visual design documents.

At operation 208, the link tag module 114 of the server machine 108 uses the link to compute the level of completeness of the developed application by comparing the number of designed components with the number of corresponding implemented entities. The link tag module 114 stores the level of completeness in the XML or JSON status file 126, which is also stored in the repository 120.

At operation 210, the server machine 108 generates design status codes and development status codes for the visual design documents. In one example embodiment, the status annotation module 116 of the server machine 108 generates the status of a specific entity in the design documents or in the development content via status annotations in the link generated by the link tag module 114. For example, a design document may include a design status that reads “ready for development” to inform the application developer that the implementation can be started because the design has been finalized or is available. In another example, the design document may include a development status that reads “read for designer review” to inform the designer that the implementation is now available for testing and review. The designer can then update the development status in the design document to “approve” or “reject” based on the outcome of the designer review.

At operation 212, the server machine 108 generates a notification to the client machine 104 of the developer to inform the developer that the visual design documents are ready for review and implementation. In one example embodiment, the status annotation module 116 updates the design status in response to the designer on the client machine 102 indicating that the visual design documents are ready to be implemented. In response, the status annotation module 116 generates the notification to the client machine 104. In another example embodiment, the status annotation module 116 identifies a developer associated with the visual design documents and notifies the corresponding developer.

At operation 214, the developer accesses and retrieves the visual design documents (uploaded by the client machine 102 of the designer) from the server machine 108. For example, the client machine 102 downloads the design document 122 from the repository 120 of the server machine 108. The developer then uses the client machine 104 to develop application content for development entities or components based on the previously retrieved visual design documents 122. The developer uploads the source code 124 corresponding to components of the visual design documents 122 in the repository 120. The status annotation module 116 detects that source code 124 related to the design document 122 have been uploaded in the repository 120 and thus automatically updates the developer status code in the link.

In another example embodiment, the developer updates the status of the development entities as components of the application are being developed at operation 216. For example, the developer may indicate a “ready for review” status for a dialog box has been implemented based on visual design documents for the dialog box. The client machine 104 communicates the status update to the status annotation module 116 of the server machine 108. In response, the status annotation module 116 updates the overall status of the application in the XML status file 126 based on the status update from the client machine 104. The XML status file 126 may be stored in the same repository 120 at the server machine 108 along with the corresponding developed source code 124 and design document 122. The update status may provide a link to a test server that executes the source code 124 for the designer to test operations related to components of the design documents.

At operation 218, the server machine 108 generates a notification to the client machine 102 to inform the designer at the client machine 102 that the implementation of the application or the developed application is ready for review. The notification may include a link to the test server. The client machine 102 may be redirected to the test server for the designer to test the implemented components of the developed application. The test server may communicate with the server machine 108 to access and execute the source code 124 stored in the repository 120 in the server machine 108.

At operation 220, the designer of the application tests the developed application or components of the developed application that are ready for review. The designer uses the client machine 102 to access the test server where the developed application is hosted.

At operation 222, the designer may approve or reject the development entities or developed application. In one example, the integrated development module 103 of the client machine 102 of the designer sends an approval notification or a rejection notification to the server machine 108.

At operation 224, the status annotation module 116 of the server machine 108 receives the approval or rejection notification and updates the corresponding developer status code in the corresponding design document 122 and the XML status file 126.

At operation 226, the server machine 108 notifies the client machine 104 of the approval or rejection status. In one example embodiment, the status annotation module 116 reports the approval or rejection status to the integrated development module 103 of the client machine 104.

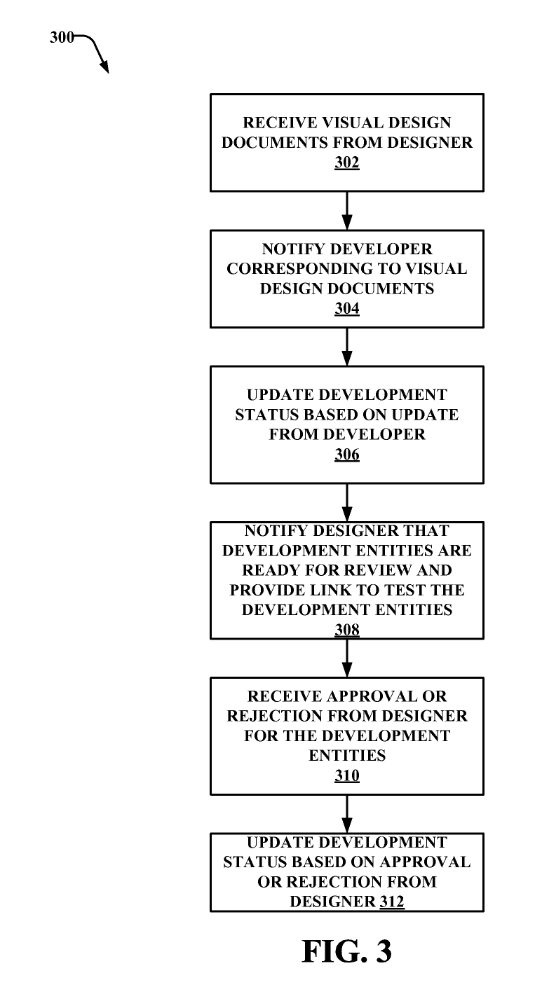

FIG. 3 is a flowchart depicting an example embodiment of a method 300 for operating an integrated development application 110.

At operation 302, visual design documents 122 are received from an application designer. In one example embodiment, the integrated development application 110 of the server machine 108 receives the visual design documents 122 from the integrated development module 103 of the client machine 102 of the application designer.

At operation 304, a notification is generated to the client machine 104 of the application developer that the visual design documents 122 are ready for review. In one example embodiment, the integrated development application 110 of the server machine 108 generates the notification to the integrated development module 103 of the client machine 104 of the application developer.

At operation 306, a status of the application development is updated based on the updates received from the application developer. In one example embodiment, the integrated development application 110 of the server machine 108 updates the developer status code.

At operation 308, a notification is generated to the application designer that the developed application is ready for review and testing in response to the status of the application development. In one example embodiment, the integrated development application 110 of the server machine 108 generates the notification to the integrated development module 103 of the client machine 102 of the application designer.

At operation 310, an approval or rejection message related to the developed application is received from the corresponding application designer. In one example embodiment, the integrated development application 110 of the server machine 108 receives the approval or rejection message from the integrated development module 103 of the client machine 102 of the application designer.

At operation 312, the development status corresponding to the developed application is updated based on the approval or rejection message. In one example embodiment, the integrated development application 110 of the server machine 108 updates the developer status code for the corresponding developed application and notifies the client machine 104 of the application developer. In another example, the rejection message includes notes and comments from the application designer.

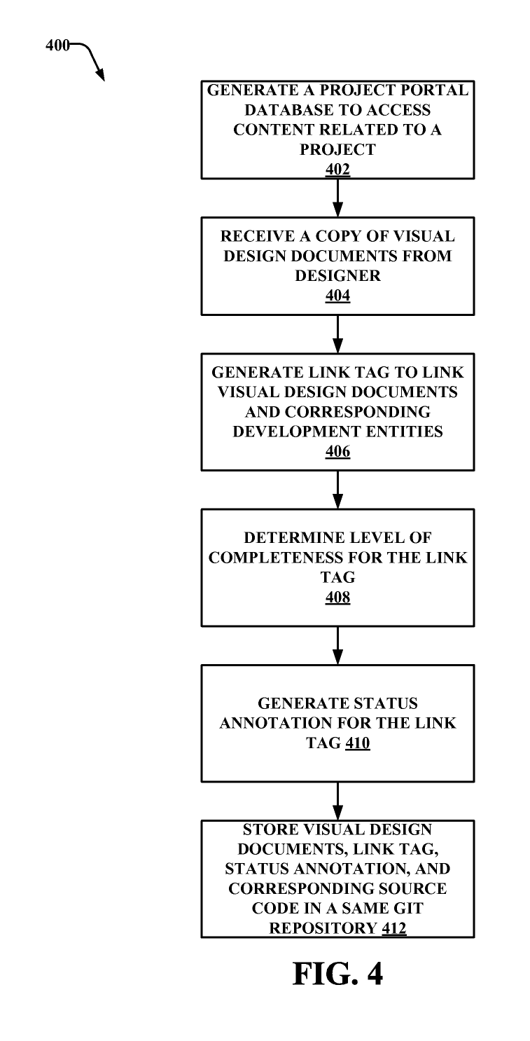

FIG. 4 is a flowchart depicting an example embodiment of a method 400 for determining a level of completeness for a development application.

At operation 402, a project portal database related to a project to develop an application is generated. The project portal database may include a table or a directory that links application designers to corresponding application developers. The project portal database stores design documents 122 and source code 124 in a same repository 120.

At operation 404, design documents 122 are received from an application designer. In one example embodiment, the project portal database may be implemented as portal module 112 in the server machine 108. The portal module 112 communicates with the integrated development module 103 and receives the design documents 122.

At operation 406, a link tag is generated to link the design documents 122 and corresponding development entities. In one example embodiment, the link tag module 114 generates the link as previously described.

At operation 408, the level of completeness may be determined based on the link tag. In one example embodiment, the link tag module 114 compares the number of designed elements from the design documents 122 with the number of implemented designed elements to compute the level of completeness. As such, if all designed elements have been implemented in the source code 124, the level of completeness would be 100%.

At operation 410, a status code is generated and annotated in the link tag. In one example embodiment, the status annotation module 116 generates the developer status code and the designer status code. The status annotation module 116 also can update the developer status code and the designer status code based on feedback or input from the application designer and the application developer.

At operation 412, the design documents 122, link tag, status annotation, and corresponding source code 124 are stored in a same Git repository, such as repository 120 of the server machine 108.

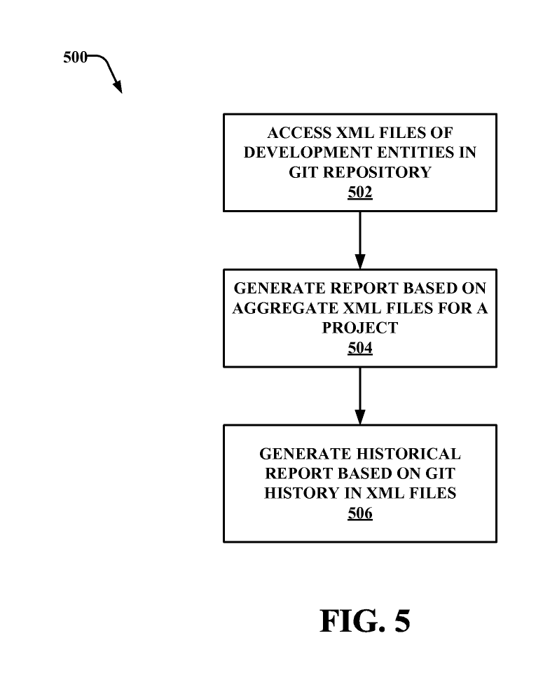

FIG. 5 is a flowchart depicting an example embodiment of a method 500 for generating a status report for a development application.

At operation 502, a request for a status update using XML status files 126 of development entities in a Git repository 120 is received. In one example embodiment, the reporting module 118 receives the request.

At operation 504, a report is generated based on the designer and developer update status for a project based on the corresponding aggregate XML status files 126 for the project. The project may include an application to be developed. The report may include chart or data points based on the content in the XML status files 126. In one example embodiment, the reporting module 118 accesses the corresponding XML status file(s) 126 in the repository 120.

At operation 506, a history report may be generated based on the git history in the XML status file 126. Since a Git repository 120 tracks versions and dates, a historical report may be generated based on the tracked versions and corresponding implemented dates. In one example embodiment, the reporting module 118 accesses the XML status file 126 in the repository 120.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as “software as a service” (SaaS). For example, at least some of the operations may be performed by a group of computers (as examples of machines including processors), these operations being accessible via a network (e.g., the network 106 (FIG. 1)) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 106.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network 106. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

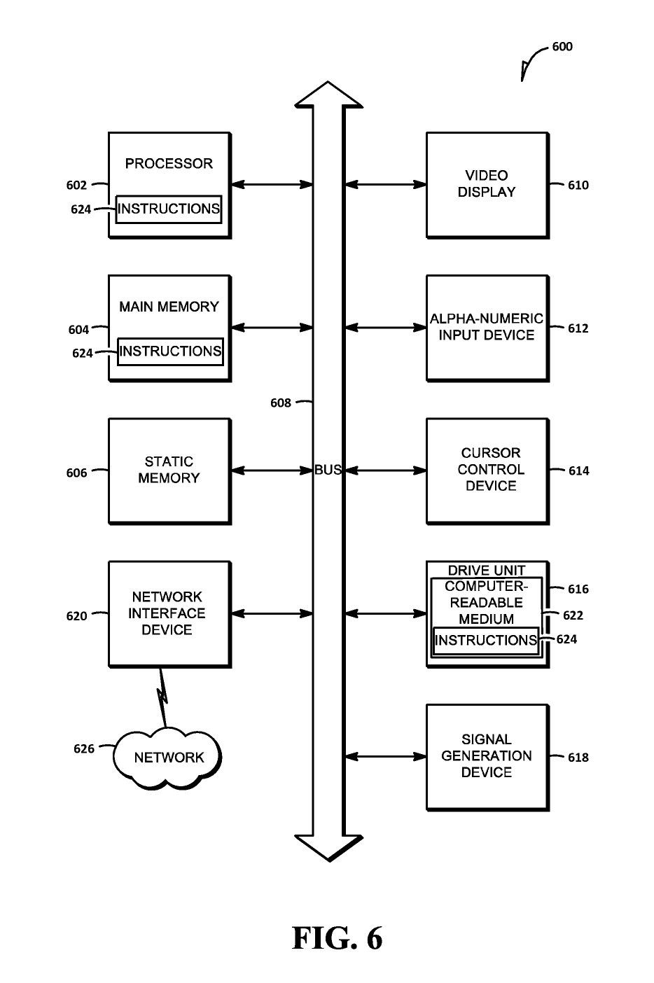

FIG. 6 is a block diagram of machine in the example form of a computer system 600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine 102, 104 in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a disk drive unit 616, a signal generation device 618 (e.g., a speaker) and a network interface device 620.

### Machine-Readable Medium

The disk drive unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media 622. The instructions 624 may also reside, completely or at least partially, within the static memory 606.

While the machine-readable medium 622 is shown in an example embodiment, to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions 624 for execution by the machine and that cause the machine to perform any one or more of the methodologies of the present embodiments, or that is capable of storing, encoding or carrying data structures utilized by or associated with such instructions 624. The term “machine-readable medium” shall accordingly be taken to include, but not be limited to, solid-state memories, and optical and magnetic media. Specific examples of machine-readable media 622 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks 626 include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions 624 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single embodiment of the invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving visual design content for an application from an application designer client;
generating, using at least one hardware processor of a machine, a link between the visual design content and development entities for the application, the link comprising a design status code and a development status code, the link identifying a repository storing a source code of the development entities;
identifying an application developer client associated with the development entities for the application; and
updating a development status of the development entities based on updates to the development status code for the source code of the development entities received at the repository from the application developer client.

2. The computer-implemented method of claim 1, further comprising:
updating the design status code in the link based on updates to the visual design content received from the application designer client; and
communicating the design status code of the visual design content to the application developer client.

3. The computer-implemented method of claim 1, further comprising:
generating a notification to the application designer client to test the application based on the development status of the development entities; and
receiving an approval notification or a rejection notification from the application designer client in response to the notification.

4. The computer-implemented method of claim 1, further comprising:
tracking a number of visual design documents and a number of implemented views based on the visual design documents;
computing a level of completeness of the application based on the ratio of the number of visual design documents to the number of implemented views; and
storing the level of completeness in an XML file in the same repository as the source code and the visual design content.

5. The computer-implemented method of claim 4, further comprising:
determining that the application is ready for review by the application designer client based on the level of completeness of the application; and
generating a link to a test server to send to the application designer client to test the application.

6. The computer-implemented method of claim 1, further comprising:
determining a change in the development status code identifying a completion of the development entities; and
generating a message to the application designer client to notify them regarding the change in the development status code identifying a completion of the development entities, the message comprising a URL link to a test server associated with the development entities.

7. The computer-implemented method of claim 6, further comprising:
receiving a rejection message from the application designer client, the rejection message comprising comments from the application designer client; and
changing the development status code to a rejection status.

8. The computer-implemented method of claim 1, further comprising:
receiving an approval message from the application designer client; and
changing the development status code to an approval status.

9. The computer-implemented method of claim 1, further comprising:
generating a portal database containing identifying information of individual developers and individual visual designers, and their corresponding contact information;
identifying at least one individual developer associated with the application;
identifying at least one individual visual designer associated with the application;
communicating a change in a visual design status to the at least one individual developer; and
communicating a change in the development status to the at least one individual visual designer.

10. The computer-implemented method of claim 1, further comprising:
storing the visual design content and the development content in a same Git repository,
wherein the visual design content comprises visual design for user interfaces for the application, and
wherein the development content comprises html files and Javascript files.

11. A server comprising:
a hardware processor comprising an integrated development application; and
a storage device comprising a repository,
the integrated development application configured to:
receive visual design content for an application from an application designer client;
generate, using the hardware processor, a link between the visual design content and development entities for the application, the link comprising a design status code and a development status code, the link identifying a repository storing a source code of the development entities;
identify an application developer client associated with the development entities for the application; and
update a development status of the development entities based on updates to the development status code for the source code of the development entities received at the repository from the application developer client.

12. The server of claim 11, wherein the integrated development application is further configured to:
update the design status code in the link based on updates to the visual design content received from the application designer client; and
communicate the design status code of the visual design content to the application developer client.

13. The server of claim 11, wherein the integrated development application is further configured to:
generate a notification to the application designer client to test the application based on the development status of the development entities; and
receive an approval notification or a rejection notification from the application designer client in response to the notification.

14. The server of claim 11, wherein the integrated development application is further configured to:
track a number of visual design documents and a number of implemented views based on the visual design documents;
compute a level of completeness of the application based on the ratio of the number of visual design documents to the number of implemented views; and
store the level of completeness in an XML file in the same repository of the source code and the visual design content.

15. The server of claim 14, wherein the integrated development application is further configured to:
determine that the application is ready for review by the application designer client based on the level of completeness of the application; and
generate a link to a test server to the application designer client to test the application.

16. The server of claim 11, wherein the integrated development application is further configured to:
determine a change in the development status code identifying a completion of the development entities; and
generate a message to the application designer client to notify them of the change in the development status code identifying a completion of the development entities, the message comprising a URL link to a test server associated with the development entities.

17. The server of claim 16, wherein the integrated development application is further configured to:
receive a rejection message from the application designer client, the rejection message comprising comments from the application designer client;
change the development status code to a rejection status;
receive an approval message from the application designer client; and
change the development status code to an approval status.

18. The server of claim 11, wherein the integrated development application is further configured to:
generate a portal database containing identifying information of individual developers and individual visual designers, and their corresponding contact information;
identify at least one individual developer associated with the application;
identify at least one individual visual designer associated with the application;
communicate a change in a visual design status to the at least one individual developer; and
communicate a change in the development status to the at least one individual visual designer.

19. The server of claim 11, wherein the integrated development application is further configured to:
store the visual design content and the development content in a same Git repository,
wherein the visual design content comprises visual design for user interfaces for the application, and
wherein the development content comprises html files and Javascript files.

20. A non-transitory machine-readable storage medium storing instructions which, when executed by at least one processor, performs operations comprising:
receiving visual design content for an application from an application designer client;
generating a link between the visual design content and development entities for the application, the link comprising a design status code and a development status code, the link identifying a repository storing a source code of the development entities;
identifying an application developer client associated with the development entities for the application; and
updating a development status of the development entities based on updates to the development status code for the source code of the development entities received at the repository from the application developer client.
